(19) United States
(12) Patent Application Publication
(10) Pub. No.: US 2026/0052057 A1
(43) Pub. Date: Feb. 19, 2026

(54) TECHNIQUES FOR SUMMARIZING CAUSATION OF DIFFERENT TYPES OF DATA RECEIVED FROM A SYSTEM

(71) Applicant: Outdoor Wireless Networks LLC, Richardson, TX (US)

(72) Inventor: Rajesh Kaliaperumal, San Jose, CA (US)

(73) Assignee: Outdoor Wireless Networks LLC, Richardson, TX (US)

(21) Appl. No.: 19/184,140

(22) Filed: Apr. 21, 2025

Related U.S. Application Data
(60) Provisional application No. 63/682,587, filed on Aug. 13, 2024.

(51) Int. Cl. H04L 41/0631; H04L 41/16

(52) U.S. Cl. CPC H04L 41/0631; H04L 41/16

(57) ABSTRACT

Techniques are provided for (x) reducing the amount of data (or elements of a set of data), provided by components of a system, which needs to be processed to more timely deliver information to a system or a user thereof which can promptly take responsive actions, e.g., remedy the underlying problem(s); and (y) translating one or more different types of data (or elements of a set of data) to a root causation description; such root causation description more directly indicates and/or suggests the underlying problem(s) which need to be remedied and optionally solution(s) for remedying the underlying problem(s). Because a device may include components from different vendors, each element may have a different data structure and content(s). Such techniques may be applied to a system comprising at least one radio access network.

### CROSS-REFERENCE TO RELATED APPLICATIONS

The present application claims benefit of U.S. Patent Application Ser. No. 63/682,587 filed Aug. 13, 2024; the entire contents of the aforementioned patent application are incorporated herein by reference as if set forth in its entirety.

### BACKGROUND

Hundreds or thousands of radio points and/or other elements of radio access networks (RANs) can substantially simultaneously generate alarms due to failure(s). Due to processing constraints of a computing system, the computing system may take hours or days to process such volume of alarms and to inform an operator and/or another system of such alarms. Thus, correction, of the underlying problem(s) giving rise to the alarms, may be correspondingly delayed. If such problem(s) affect the RAN(s)'ability to operate, continuity of service of the RAN(s) is detrimentally diminished.

### SUMMARY OF THE INVENTION

In some aspects, the techniques described herein relate to a method of summarizing causation(s) of data received from a system including at least one device, wherein each device includes at least one component, the method including: receiving a set of at least one element of data about at least one of the at least one component; converting or retaining a format of each element of data of the set; vectorizing, using a first artificial intelligence, each element of the set; using vectorized elements of the set, identifying one or more subsets of elements, of the set, each of whose elements have a similarity greater than a similarity threshold level; deleting all but one element from each identified subset of elements; determining whether a number of remaining elements in the set is less than an element threshold level; determining that the number of remaining elements in the set is not less than the element threshold level, then, using the vectorized elements of the set, identifying at least one additional subset of elements each of whose elements have a similarity greater than a reduced similarity threshold level, wherein the reduced similarity threshold level is less than the similarity threshold level; removing all but one element from each subset of remaining elements; and using a relationship between one or more types of data and at least one root cause description each of which causes at least one type of data, generating at least one description of a causation which causes each type of subset of remaining elements.

In some aspects, the techniques described herein relate to a program product including a non-transitory processor readable medium on which program instructions are embodied, wherein the program instructions are configured, when executed by at least one programmable processor, to cause the at least one programmable processor to execute a process to summarize causation(s) of data received from a system including at least one device, wherein each device includes at least one component, the process including: receiving a set of at least one element of data about at least one of the at least one component; converting or retaining a format of each element of data of the set; causing vectorization, using a first artificial intelligence, of each element of the set; using vectorized elements of the set, identifying one or more subsets of elements, of the set, each of whose elements have a similarity greater than a similarity threshold level; deleting all but one element from each identified subset of elements; determining whether a number of remaining elements in the set is less than an element threshold level; determining that the number of remaining elements in the set is not less than the element threshold level, then, using the vectorized elements of the set, identifying at least one additional subset of elements each of whose elements have a similarity greater than a reduced similarity threshold level, wherein the reduced similarity threshold level is less than the similarity threshold level; removing all but one element from each subset of remaining elements; and using a relationship between one or more types of data and at least one root cause description each of which causes at least one type of data, generating or causing to be generated at least one description of a causation which causes each type of subset of remaining elements.

In some aspects, the techniques described herein relate to an apparatus for summarizing causation(s) of data received from a system including at least one device, wherein each device includes at least one component, the apparatus including: processing system including at least one processing circuit communicatively coupled to at least one memory circuit, wherein the processing system is communicatively coupled to at least one component of the at least one device, and wherein the processing system is configured to: receive a set of at least one element of data about at least one of the at least one component; convert or retain a format of each element of data of the set; vectorize, using a first artificial intelligence, each element of the set; using vectorized elements of the set, identify one or more subsets of elements of the set, each of whose elements have a similarity greater than a similarity threshold level; delete all but one element from each identified subset of elements; determine whether a number of remaining elements in the set is less than an element threshold level; determine that the number of remaining elements in the set is not less than the element threshold level, then, using the vectorized elements of the set, identify at least one additional subset of elements each of whose elements have a similarity greater than a reduced similarity threshold level, wherein the reduced similarity threshold level is less than the similarity threshold level; remove all but one element from each subset of remaining elements; and using a relationship between one or more types of data and at least one root cause description each of which causes at least one type of data, generate at least one description of a causation which causes each type of subset of remaining elements.

### BRIEF DESCRIPTION OF THE DRAWINGS

Comprehension of embodiments of the invention is facilitated by reading the following detailed description in conjunction with the annexed drawings, in which:

FIG. 1 illustrates a diagram of one embodiment of an artificial intelligence training system which may be used to train artificial intelligence used by embodiments of the invention;

FIG. 2 illustrates a block diagram of one embodiment of a processing system;

FIG. 3 illustrates a flow diagram of one embodiment of a method of generating a relationship between each type of alarm generated by a component of a radio access network and a corresponding root causation which gives rise to the alarm;

FIG. 4 illustrates a block diagram of an exemplary telecommunications system configured to utilize embodiments of the invention;

FIG. 5 illustrates a flow diagram of one embodiment of a method of summarizing causation(s) of data received from at least one system;

FIG. 6A illustrates a diagram of one embodiment of data structures of elements of a set of data of one type of data; and

FIG. 6B illustrates a diagram of one embodiment of common data structures of elements of the set of data of the one type of data.

In accordance with common practice, the various described features are not drawn to scale but are drawn to emphasize specific features relevant to the exemplary embodiments. Reference characters denote like elements throughout figures and text.

### DETAILED DESCRIPTION

For pedagogical purposes, embodiments of the invention will typically be described in the context of RAN(s) and alarms generated by component(s) of the RAN(s). However, embodiments of the invention pertain to devices other than a RAN and data provided by component(s) of such device(s) other than alarms. Thus, an alarm may be more generally described as an element of a set of data. Further, types of alarms may be more generally described types of elements. Optionally, such elements may also be log files provided by the component(s).

Embodiments of the invention include techniques for:
(a) reducing the amount of data (or elements of a set of data), provided by components of a system, which needs to be processed to more timely deliver information to a system or a user thereof which can promptly take responsive actions, e.g., remedy the underlying problem(s); and
(b) translating one or more different types of data (or elements of a set of data) to a root causation description; such root causation description more directly indicates and/or suggests the underlying problem(s) which need to be remedied and optionally solution(s) for remedying the underlying problem(s). For example, alarms indicating loss of user plane and control plane communications may have the same root causation.
   Because a device may include components from different vendors, each element may have a different data structure and content(s). Optionally, to further reduce alarm processing time, some or all items of data of a data type are converted to a common format for that data type.

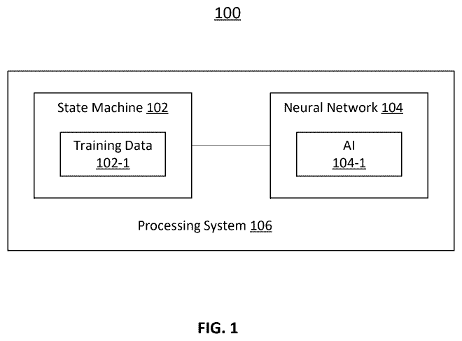

Embodiments of the invention utilize at least one artificial intelligence (AI), e.g., a generative artificial intelligence, implemented with a neural network. Each artificial intelligence may be pre-existing, i.e., previously created, or need to be created. In the later case, the artificial intelligence is trained on a neural network. FIG. 1 illustrates a diagram of one embodiment of an artificial intelligence training system 100 which may be used to train artificial intelligence used by embodiments of the invention. The artificial intelligence training system 100 includes a state machine 102 communicatively coupled to a neural network 104. The state machine 102 includes training data 102-1 configured to be provided to the neural network 104 to create the artificial intelligence 104-1. A processing system (or processing circuitry) 106 includes the state machine 102 and the neural network 104.

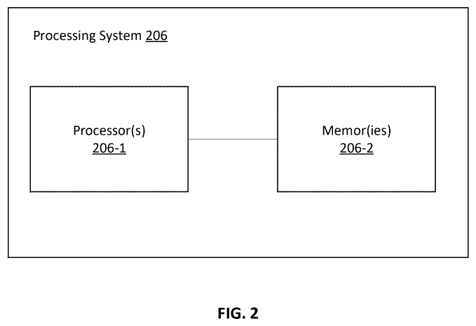

FIG. 2 illustrates a block diagram of one embodiment of a processing system 206. The processing system includes at least one processor (or at least one processor circuitry 206-1 communicatively coupled to at least one memory (or at least one memory circuitry) 206-2.

Because embodiments of the invention translate one or more types of data to the root cause description, a relationship between the one or more types of data and the root cause description must be generated. The relationship may be embodied by a data translation software file or database, an artificial intelligence, or any other means. Optionally, the data translation software file or database, or other means, may be generated with the use of artificial intelligence.

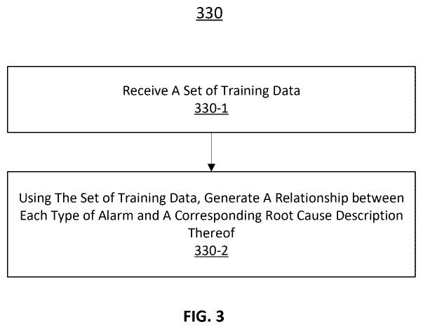

FIG. 3 illustrates a flow diagram of one embodiment of a method 330 of generating a relationship between each type of alarm generated by a component of a radio access network and a corresponding root causation which gives rise to the alarm. To the extent that the methods shown in any of the Figures is described herein as being implemented in the system shown in FIGS. 1, 2, and/or 4, it is to be understood that other embodiments can be implemented in other ways. The blocks of the flow diagrams have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner).

In block 330-1, a set of training data, providing exemplary alarms and a root causation description for each alarm, is received, e.g., by a neural network (for example an artificial intelligence therein) from a state machine. The set of training data may be for one or more different types of radio access networks. In block 330-2, using the set of training data, a relationship between each type of alarm, e.g., of one or more different RANs, and a root causation description is generated. Optionally, the relationship is stored in memor(ies) of the processing system.

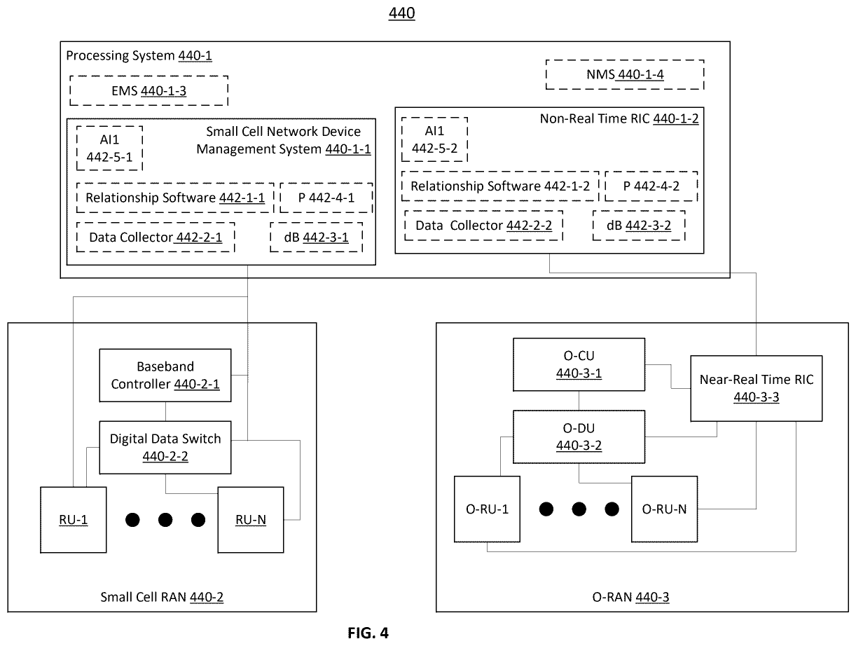

FIG. 4 illustrates a block diagram of an exemplary telecommunications system 440 configured to utilize embodiments of the invention. As indicated elsewhere herein, other types of systems other than a telecommunications system may be use embodiments of the invention. The exemplary telecommunications system 440 is set forth only for pedagogical purposes.

The telecommunications system 440 includes a processing system (or processing circuitry) 440-1 communicatively coupled to at least one device, e.g., at least one radio access network. For pedagogical purposes, the processing system 440-1 is illustrated in FIG. 4 as being communicatively coupled to a small cell RAN 440-2 and an Open RAN (O-RAN) 440-3.

Optionally, the processing system 440-1 may be at least one cloud computing system, at least one server, and/or any other computing system(s). Optionally, the processing system, or a component thereof, may be implemented in a manner described with respect to FIG. 2. The processing system 440-1 is configured to execute at least one management system configured to (a) receive data from and/or control one or more of the at least one radio access networks and (b) execute embodiment(s) of the invention.

For pedagogical purposes, FIG. 4 illustrates two management systems: a small cell network device management system 440-1-1 and a non-real time RAN intelligent controller (or non-real time RIC) 440-1-2. The small cell network device management system 440-1-1 is configured to receive data from and/or control the small cell RAN 440-2. The non-real time RIC 440-1-2 is configured to receive data from and/or control the O-RAN 440-3.

Embodiments of the invention may be executed by the management system which receives data from a radio access network or by another component located elsewhere in the processing system 440-1. For pedagogical purposes, each management system will be illustrated herein as executing embodiments of the invention. Thus, each of the small cell network device management system 440-1-1 and the non-real time RIC 440-1-2 optionally include a relationship software 442-1-1, 442-1-2, a data collector 442-2-1, 442-2-2, a database (dB) 442-3-1, 442-3-2, a predictor (P) 442-4-1, 442-4-2, a first AI (AI1) 442-5-1, 442-5-2, a correlation analyzer (CA) 442-6-1, 442-6-2, and/or a grouping aggregator (GA) 442-7-1, 442-7-2; for purposes of clarity, each of such components is optional. However, in other embodiments, one or more of such components may be located elsewhere in the processing system 440-1.

The relationship software 442-1-1, 442-2-1 is configured to generate a relationship between each type of data element, e.g., each type of alarm, and a root causation giving rise to the data element, e.g., the alarm. Optionally, the relationship software 442-1-1, 442-2-1 may be implemented by a second artificial intelligence and/or a translation data file for example a database. Optionally, the second artificial intelligence may be implemented with a decoder configured to generate the root causation in a human readable form. Optionally, the translation data file may translate domain specific data to domain specific causation; the domain may be a device, e.g., a radio access network.

The data collector 442-2-1, 442-2-2 is software for facilitating collection of data and may be a virtual network function event streaming (VES) collector, a Kafka stream, and/or Logstash. The predictor 442-4-1, 442-4-2 is an algorithm which is configured to receive root causation(s) generated by embodiments of the invention, and predict, using the received root causation(s), future system, e.g., RAN, failures. The first AI 442-5-1, 442-5-2 is configured to perform vectorization as described elsewhere herein. Optionally, the first AI 442-5-1, 442-5-2 is implemented with an encoder which performs such vectorization which may also be referred to as embedding.

The correlation analyzer 442-6-1, 442-6-2 is configured to receive data from the first artificial intelligence 442-5-1, 442-5-2 and remove duplicate data elements. The grouping aggregator 442-7-1, 442-7-2 is configured to receive data from the correlation analyzer 442-6-1, 442-6-2 or the first artificial intelligence 442-5-1, 442-5-2, and to aggregate data elements which are similar (and likely a result of a same underlying problem).

Optionally, all or part of the functionality of embodiments of the invention when implemented in the non-real time RIC 440-1-2 is embedded in an rApp configured to be executed by the non-real time RIC 440-1-2. Thus, optionally, the relationship software 442-1-2, the data collector 442-2-2, and/or the database (dB) 442-3-2 in the non-real time RIC 440-1-2 may be implemented in such rApp.

Optionally, the processing system 440-1 includes (a) an element management system (EMS) 440-1-3 configured to manage telecommunications network management components, e.g., the small cell network device management system 442-1-1 and/or the non-real time RIC 440-1-2, and/or a network management system (NMS) 440-1-4 configured to provision, monitor, and maintain a telecommunications network and components thereof, the small cell network device management system 442-1-1 and/or the non-real time RIC 440-1-2.

The small cell RAN 440-2, and components thereof, are communicatively coupled to a management system, e.g., the small cell network device management system 440-1-1. The small cell RAN 440-2 includes a baseband controller 440-2-1, a digital data switch 440-2-2, and N radio units (RUs) RU-1, RU-N. N is an integer greater than zero. The baseband controller 440-2-1 is communicatively coupled to the data switch 440-2-2. The digital data switch 440-2-2 is communicatively coupled each of the N radio units RU-1, RU-N. Each of the N radio units RU-1, RU-N, the baseband controller 440-2-1, and the digital data switch 440-2-2 are communicatively coupled to the small cell network device management system 440-1-1.

The O-RAN 440-3, and components thereof, are communicatively coupled to a management system, e.g., the non-real time RIC 440-1-2, through a near-real time RIC 440-3-3. The O-RAN 440-3 includes an open-central unit (O-CU) 440-3-1, an open distributed unit (O-DU) 440-3-2, the near-real time RIC 440-3-3, and M open radio units (O-RUs) O-RU-1, O-RU-M. N is an integer greater than zero. The near-real time RIC 440-3-3 is communicatively coupled to the non-real-time RIC 440-1-2. The near-real time RIC 440-3-3 is communicatively coupled to each of the O-CU 440-3-1, the O-DU 440-3-2, and each O-RU O-RU-1, O-RU-M. The O-CU 440-3-1 is communicatively coupled to the O-DU 440-3-2. The O-DU 440-3-2 is communicatively coupled to each O-RU O-RU-1, O-RU-M.

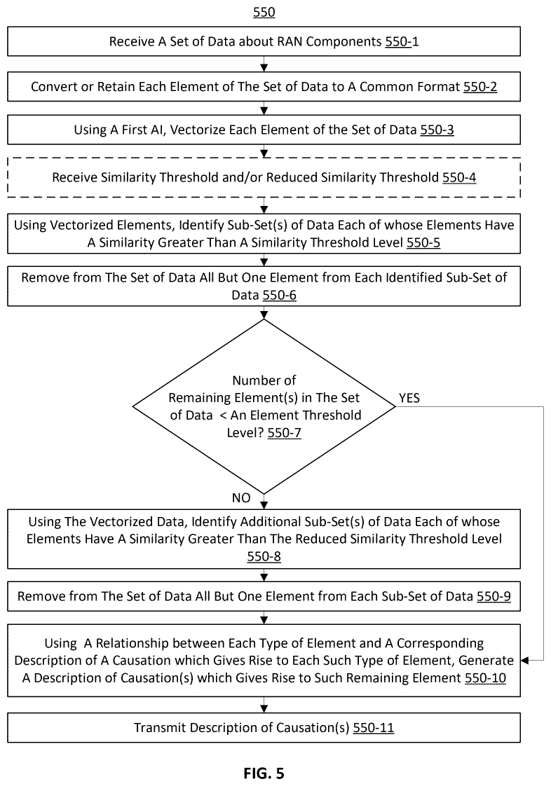

FIG. 5 illustrates a flow diagram of one embodiment of a method 550 of summarizing causation(s) of data received from at least one device, e.g., a telecommunications system including at least one radio access network. In block 550-1, a set of at least one element of data about components of at least one RAN is received, e.g., through data collector(s), from the at least one RAN. Optionally, the set of data is stored in the database(s).

In block 550-2, a format of each element of the set is converted to or is retained in a common format for a type of data of the element. For example, when a management system supervises one or more devices, e.g., RAN(s), such device(s) utilize components from different manufacturers, the format of each element of a type of data may vary amongst vendors. Some of the different formats may include extraneous information; optionally, extraneous information in some of the at least some elements is removed when performing such conversion.

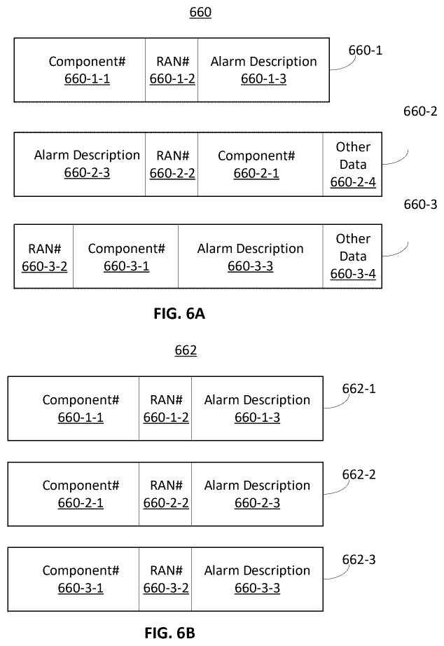

FIG. 6A illustrates a diagram of one embodiment of data structures of elements of a set of data of one type of data 660, e.g., from component(s) of one or more RAN(s) communicatively coupled to a management system. Such data structures do not have a common data structure. For pedagogical purposes, the set of data of the one type of data 660 includes a first element 660-1, a second element 660-2, and a third element 660-3; however, the set may have more or less elements. For pedagogical purposes, each illustrated element shares at least one common data field, e.g., three common data fields: RAN component number (component #) 660-1-1, 660-2-1, 660-3-1, RAN number (RAN #) 660-1-2, 660-2-2, 660-3-2, and alarm description 660-1-3, 660-2-3, 660-3-3. Optionally, each of the second element 660-2 and the third element 660-3 include other, i.e., extraneous, data 660-2-4, 660-3-4 which may be different in each element.

In block 550-2, each element 660-1, 660-2, 660-3 is converted to or retained in a common data format. FIG. 6B illustrates a diagram of one embodiment of common data structures of elements of the set of data of the one type of data 662, e.g., from the component(s) of the one or more RAN(s) communicatively coupled to the management system. The set of data of the one type of data 662 includes a retained element 662-1, a first converted element 662-2, and a second converted element 662-3. Such data structures of each such elements 662-1, 662-2, 662-3 have a common (or same) data structure in which a first data structure portion is the RAN component number 660-1-1, 660-2-1, 660-3-1, a second data structure portion is the RAN number 660-1-2, 660-2-2, 660-3-2, and a third data structure portion an alarm description 660-1-3, 660-2-3, 660-3-3. The second data structure portion follows the first data structure portion and precedes the third data structure portion.

Returning to FIG. 5, in block 550-3, each element of the set is vectorized using a first artificial intelligence. Vectorization is a natural language process which converts text data into a numerical representation, e.g., an integer representation, which can be processed by an algorithm, e.g., a similarity algorithm.

In optional block 550-4, a similarity threshold level and/or a reduced similarity threshold level is received. The reduced similarity threshold level is less than the similarity threshold level. Optionally, the similarity threshold level and/or the reduced similarity threshold level is a function of the type of device(s), e.g., RAN(s), which generate the set. Optionally, the similarity threshold level and/or the reduced similarity threshold level is received through a user interface¹, for example of the EMS or NMS; alternatively, the similarity threshold level and/or the reduced similarity threshold level is stored in the processing system, e.g., in the database. Optionally, the similarity threshold level and/or the reduced similarity threshold level are each a function of a number of elements of the set; the threshold may be increased as the number of elements of the set increases. 1 For example, an operator or a system may provide the similarity threshold and/or the reduced similarity threshold which may be based on experience and/or which may vary due to model drift.

In block 550-5 and using the vectorized elements of the set, one or more subset(s), of the set, each of whose elements have a similarity greater than a similarity threshold level are identified. Optionally, similarity may be determined using a cosine similarity algorithm, a Euclidian distance algorithm, a Jaccard similarity algorithm, and/or any other similarity algorithm.

In block 550-6, all but one element, from each identified subset of elements of the set, is deleted or removed. Thus, referring to FIG. 6B, only one of the elements 662-1, 662-2, 662-3 would be retained. Optionally, each single element of each subset of elements of the set is stored in the database.

Returning to FIG. 5, in block 550-7, whether a number of remaining elements in the set is less than an element threshold level is determined. Optionally, the element threshold level is defined by a user and/or a system and optionally may be stored in the database; optionally, the element threshold level may be provided through the EMS and/or NMS, e.g., a user interface thereof, described elsewhere herein. If the number of remaining elements in the set is less than the element threshold level, then proceed to block 550-10.

If the number of remaining elements in the set is not less than the element threshold level, then in block 550-8 and using the vectorized elements of the set, at least one additional subset of elements, each of whose elements have a similarity greater than a reduced similarity threshold level, is identified. In block 550-9, all but one element from each subset of the remaining elements is removed. Thus, for each subset with only one element, e.g., resulting from block 550-6, no action need be taken. Optionally, each single element of each subset of the set is stored in the database.

In block 550-10 and using a relationship between one or more types of data and at least one root cause description each of which causes at least one type of data, at least one description of a causation which causes each type of subset of remaining elements is generated using a relationship between each type of element and a corresponding description of causation which gives rise to each such type of subset. Optionally, block 550-10 is performed by the relationship software described elsewhere herein. Optionally, such generated description(s) of causation are stored in the database; optionally, the type of element giving rise to such generated description(s) is stored with each corresponding generated description. Optionally, in block 550-11, each generated description of a causation is transmitted, e.g., to a management system, e.g., an EMS and/or an NMS, (for example a user interface thereof, and/or to software, e.g., on the processing system, e.g., in a RAN management system, which predicts future faults.

The processor circuitry described herein may include one or more microprocessors, microcontrollers, digital signal processing (DSP) elements, application-specific integrated circuits (ASICs), and/or field programmable gate arrays (FPGAs). In this exemplary embodiment, processor circuitry includes or functions with software programs, firmware, or other computer readable instructions for carrying out various process tasks, calculations, and control functions, used in the methods described herein. These instructions are typically tangibly embodied on any storage media (or computer readable medium) used for storage of computer readable instructions or data structures.

The memory circuitry described herein can be implemented with any available storage media (or computer readable medium) that can be accessed by a general purpose or special purpose computer or processor, or any programmable logic device. Suitable computer readable medium may include storage or memory media such as semiconductor, magnetic, and/or optical media. For example, computer readable media may include conventional hard disks, Compact Disk-Read Only Memory (CD-ROM), DVDs, volatile or non-volatile media such as Random Access Memory (RAM) (including, but not limited to, Dynamic Random Access Memory (DRAM)), Read Only Memory (ROM), Electrically Erasable Programmable ROM (EEPROM), and/or flash memory. Combinations of the above are also included within the scope of computer readable media.

Methods of the invention can be implemented in computer readable instructions, such as program modules or applications, which may be stored in the computer readable medium that is part of (optionally the memory circuitry) or communicatively coupled to the processing circuitry, and executed by the processing circuitry, optionally the processor circuitry. Generally, program modules or applications include routines, programs, objects, data components, data structures, algorithms, and the like, which perform particular tasks or implement particular abstract data types.

Databases as used herein may be either conventional databases or data storage formats of any type, e.g., data files. Although separate databases are recited herein, one or more of such databases may be combined.

### EXEMPLARY EMBODIMENTS

Example 1 includes a method of summarizing causation(s) of data received from a system including at least one device, wherein each device includes at least one component, the method comprising: receiving a set of at least one element of data about at least one of the at least one component; converting or retaining a format of each element of data of the set; vectorizing, using a first artificial intelligence, each element of the set; using vectorized elements of the set, identifying one or more subsets of elements, of the set, each of whose elements have a similarity greater than a similarity threshold level; deleting all but one element from each identified subset of elements; determining whether a number of remaining elements in the set is less than an element threshold level; determining that the number of remaining elements in the set is not less than the element threshold level, then, using the vectorized elements of the set, identifying at least one additional subset of elements each of whose elements have a similarity greater than a reduced similarity threshold level, wherein the reduced similarity threshold level is less than the similarity threshold level; removing all but one element from each subset of remaining elements; and using a relationship between one or more types of data and at least one root cause description each of which causes at least one type of data, generating at least one description of a causation which causes each type of subset of remaining elements.

Example 2 includes the method of Example 1, wherein converting the format of an element of data of the set comprises removing information from the element of data.

Example 3 includes the method of any of Examples 1-2, wherein each element of data is an alarm or a log file generated by a component of a device.

Example 4 includes the method of any of Examples 1-3, wherein the system is a telecommunications system and wherein the at least one device includes a radio access network.

Example 5 includes the method of any of Examples 1-4, further comprising receiving the similarity threshold level and/or the reduced similarity threshold level.

Example 6 includes the method of any of Examples 1-5, wherein, using the relationship between one or more type of data and the at least one root cause description each of which causes the at least one type of data comprises using a second artificial intelligence.

Example 7 includes the method of any of Examples 1-6, further comprising transmitting each description of causation to a management system configured to manage the system.

Example 8 includes a program product comprising a non-transitory processor readable medium on which program instructions are embodied, wherein the program instructions are configured, when executed by at least one programmable processor, to cause the at least one programmable processor to execute a process to summarize causation(s) of data received from a system including at least one device, wherein each device includes at least one component, the process comprising: receiving a set of at least one element of data about at least one of the at least one component; converting or retaining a format of each element of data of the set; causing vectorization, using a first artificial intelligence, of each element of the set; using vectorized elements of the set, identifying one or more subsets of elements, of the set, each of whose elements have a similarity greater than a similarity threshold level; deleting all but one element from each identified subset of elements; determining whether a number of remaining elements in the set is less than an element threshold level; determining that the number of remaining elements in the set is not less than the element threshold level, then, using the vectorized elements of the set, identifying at least one additional subset of elements each of whose elements have a similarity greater than a reduced similarity threshold level, wherein the reduced similarity threshold level is less than the similarity threshold level; removing all but one element from each subset of remaining elements; and using a relationship between one or more types of data and at least one root cause description each of which causes at least one type of data, generating or causing to be generated at least one description of a causation which causes each type of subset of remaining elements.

Example 9 includes the program product of Example 8, wherein converting the format of an element of data of the set comprises removing information from the element of data.

Example 10 includes the program product of any of Examples 8-9, wherein each element of data is an alarm or a log file generated by a component of a device.

Example 11 includes the program product of any of Examples 8-10, wherein the system is a telecommunications system and wherein the at least one device includes a radio access network.

Example 12 includes the program product of any of Examples 8-11, wherein the process further comprises receiving the similarity threshold level and/or the reduced similarity threshold level.

Example 13 includes the program product of any of Examples 8-12, wherein using the relationship between one or more type of data and the at least one root cause description each of which causes the at least one type of data comprises using a second artificial intelligence.

Example 14 includes the program product of any of Examples 8-13, wherein the process further comprises causing transmission of each description of causation to a management system configured to manage the system.

Example 15 includes an apparatus for summarizing causation(s) of data received from a system including at least one device, wherein each device includes at least one component, the apparatus comprising: processing system including at least one processing circuit communicatively coupled to at least one memory circuit, wherein the processing system is communicatively coupled to at least one component of the at least one device, and wherein the processing system is configured to: receive a set of at least one element of data about at least one of the at least one component; convert or retain a format of each element of data of the set; vectorize, using a first artificial intelligence, each element of the set; using vectorized elements of the set, identify one or more subsets of elements of the set, each of whose elements have a similarity greater than a similarity threshold level; delete all but one element from each identified subset of elements; determine whether a number of remaining elements in the set is less than an element threshold level; determine that the number of remaining elements in the set is not less than the element threshold level, then, using the vectorized elements of the set, identify at least one additional subset of elements each of whose elements have a similarity greater than a reduced similarity threshold level, wherein the reduced similarity threshold level is less than the similarity threshold level; remove all but one element from each subset of remaining elements; and using a relationship between one or more types of data and at least one root cause description each of which causes at least one type of data, generate at least one description of a causation which causes each type of subset of remaining elements.

Example 16 includes the apparatus of Example 15, wherein convert the format of an element of data of the set comprises remove information from the element of data.

Example 17 includes the apparatus of any of Examples 15-16, wherein each element of data is an alarm or a log file generated by a component of a device.

Example 18 includes the apparatus of any of Examples 15-17, wherein the system is a telecommunications system and wherein the at least one device includes a radio access network.

Example 19 includes the apparatus of any of Examples 15-18, wherein the processing system is further configured to receive the similarity threshold level and/or the reduced similarity threshold level.

Example 20 includes the apparatus of any of Examples 15-19, wherein using the relationship between one or more type of data and the at least one root cause description each of which causes the at least one type of data comprises using a second artificial intelligence.

Example 21 includes the apparatus of any of Examples 15-20, wherein the processing system is further configured to cause transmission of each description of causation to a management system configured to manage the system.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. A method of summarizing causation(s) of data received from a system including at least one device, wherein each device includes at least one component, the method comprising:
receiving a set of at least one element of data about at least one of the at least one component;
converting or retaining a format of each element of data of the set;
vectorizing, using a first artificial intelligence, each element of the set;
using vectorized elements of the set, identifying one or more subsets of elements, of the set, each of whose elements have a similarity greater than a similarity threshold level;
deleting all but one element from each identified subset of elements;
determining whether a number of remaining elements in the set is less than an element threshold level;
determining that the number of remaining elements in the set is not less than the element threshold level, then, using the vectorized elements of the set, identifying at least one additional subset of elements each of whose elements have a similarity greater than a reduced similarity threshold level, wherein the reduced similarity threshold level is less than the similarity threshold level;
removing all but one element from each subset of remaining elements; and
using a relationship between one or more types of data and at least one root cause description each of which causes at least one type of data, generating at least one description of a causation which causes each type of subset of remaining elements.

2. The method of claim 1, wherein converting the format of an element of data of the set comprises removing information from the element of data.

3. The method of claim 1, wherein each element of data is an alarm or a log file generated by a component of a device.

4. The method of claim 1, wherein the system is a telecommunications system and wherein the at least one device includes a radio access network.

5. The method of claim 1, further comprising receiving the similarity threshold level and/or the reduced similarity threshold level.

6. The method of claim 1, wherein, using the relationship between one or more type of data and the at least one root cause description each of which causes the at least one type of data comprises using a second artificial intelligence.

7. The method of claim 1, further comprising transmitting each description of causation to a management system configured to manage the system.

8. A program product comprising a non-transitory processor readable medium on which program instructions are embodied, wherein the program instructions are configured, when executed by at least one programmable processor, to cause the at least one programmable processor to execute a process to summarize causation(s) of data received from a system including at least one device, wherein each device includes at least one component, the process comprising:
receiving a set of at least one element of data about at least one of the at least one component;
converting or retaining a format of each element of data of the set;
causing vectorization, using a first artificial intelligence, of each element of the set;
using vectorized elements of the set, identifying one or more subsets of elements, of the set, each of whose elements have a similarity greater than a similarity threshold level;
deleting all but one element from each identified subset of elements;
determining whether a number of remaining elements in the set is less than an element threshold level;
determining that the number of remaining elements in the set is not less than the element threshold level, then, using the vectorized elements of the set, identifying at least one additional subset of elements each of whose elements have a similarity greater than a reduced similarity threshold level, wherein the reduced similarity threshold level is less than the similarity threshold level;
removing all but one element from each subset of remaining elements; and
using a relationship between one or more types of data and at least one root cause description each of which causes at least one type of data, generating or causing to be generated at least one description of a causation which causes each type of subset of remaining elements.

9. The program product of claim 8, wherein converting the format of an element of data of the set comprises removing information from the element of data.

10. The program product of claim 8, wherein each element of data is an alarm or a log file generated by a component of a device.

11. The program product of claim 8, wherein the system is a telecommunications system and wherein the at least one device includes a radio access network.

12. The program product of claim 8, wherein the process further comprises receiving the similarity threshold level and/or the reduced similarity threshold level.

13. The program product of claim 8, wherein using the relationship between one or more type of data and the at least one root cause description each of which causes the at least one type of data comprises using a second artificial intelligence.

14. The program product of claim 8, wherein the process further comprises causing transmission of each description of causation to a management system configured to manage the system.

15. An apparatus for summarizing causation(s) of data received from a system including at least one device, wherein each device includes at least one component, the apparatus comprising:
processing system including at least one processing circuit communicatively coupled to at least one memory circuit, wherein the processing system is communicatively coupled to at least one component of the at least one device, and wherein the processing system is configured to:
receive a set of at least one element of data about at least one of the at least one component;
convert or retain a format of each element of data of the set;
vectorize, using a first artificial intelligence, each element of the set;
using vectorized elements of the set, identify one or more subsets of elements of the set, each of whose elements have a similarity greater than a similarity threshold level;
delete all but one element from each identified subset of elements;
determine whether a number of remaining elements in the set is less than an element threshold level;
determine that the number of remaining elements in the set is not less than the element threshold level, then, using the vectorized elements of the set, identify at least one additional subset of elements each of whose elements have a similarity greater than a reduced similarity threshold level, wherein the reduced similarity threshold level is less than the similarity threshold level;
remove all but one element from each subset of remaining elements; and
using a relationship between one or more types of data and at least one root cause description each of which causes at least one type of data, generate at least one description of a causation which causes each type of subset of remaining elements.

16. The apparatus of claim 15, wherein convert the format of an element of data of the set comprises remove information from the element of data.

17. The apparatus of claim 15, wherein each element of data is an alarm or a log file generated by a component of a device.

18. The apparatus of claim 15, wherein the system is a telecommunications system and wherein the at least one device includes a radio access network.

19. The apparatus of claim 15, wherein the processing system is further configured to receive the similarity threshold level and/or the reduced similarity threshold level.

20. The apparatus of claim 15, wherein using the relationship between one or more type of data and the at least one root cause description each of which causes the at least one type of data comprises using a second artificial intelligence.

21. The apparatus of claim 15, wherein the processing system is further configured to cause transmission of each description of causation to a management system configured to manage the system.
